(19) United States
(12) Patent Application Publication
(10) Pub. No.: US 2024/0098395 A1
(43) Pub. Date: Mar. 21, 2024

(54) Adjustable Sound Bar End Cap

(71) Applicant: Nicholas Charles Berry, Beaverton, OR (US)

(72) Inventor: Nicholas Charles Berry, Beaverton, OR (US)

(21) Appl. No.: 18/388,860

(22) Filed: Nov. 13, 2023

Related U.S. Application Data
(60) Provisional application No. 63/407,599, filed on Sep. 16, 2022.

(51) Int. Cl. H04R 1/02

(52) U.S. Cl. CPC H04R 1/025; H04R 2201/02

(57) ABSTRACT

Improvements in an adjustable sound bar end cap to allow for the end caps to be outwardly adjustable relative to the frame. The end caps translate from the frame to provide movement of the end caps to match exact variations due to differences in finishes widths per different brands. Springs push the end caps from the frame to maintain a constant pressure between the frame and the end cap(s). This configuration gives 0 to 1 inch of movement per side. The fastener compresses the spring to remain in compression. Multiple fasteners allow for even compression and perpendicular fit of the end cap relative to the frame. A cover plate that covers the adjustment mechanism and adjustment screws. The cover is made from a ferrous material that is attracted to a magnet within the frame to allow for secure holding of the cover plate and easy removal.

### CROSS-REFERENCE TO RELATED APPLICATIONS

Not Applicable.

### PRIOR ART

U.S. published application 2012/0308065 was published on Dec. 6, 2012, for Ernie Padalino et al, and is titled “Sound Bar”. This publication discloses a sound bar includes a housing, a rotary member, first and second speaker boxes, and a gear mechanism. The rotary member is rotatable with respect to the housing. The first and second speaker boxes are slidable with respect to the housing, respectively. The first and second speaker boxes are disposed at opposite end portions of the housing in a lengthwise direction of the housing, respectively. The gear mechanism is disposed between the rotary member and the first and second speaker boxes. The gear mechanism is configured to slide both the first and second speaker boxes with respect to the housing in opposite directions of the housing along the lengthwise direction of the housing in response to a rotational movement of the rotary member. While this patent discloses an adjustable length to a sound bar, this patent discloses adjusting in the middle of the sound bar.

U.S. Pat. No. 6,641,405 issued on Nov. 4, 2003, to Chin-Yi Chou and is titled Vehicular Power Plug with Adjustable Length. This patent discloses a length-adjustable vehicular power plug for use with a vehicular electrical appliance is disclosed for transmitting the power to the vehicular electrical appliance; a first sleeve body connected to the plug end for supporting the plug end; a second sleeve body connected to the connector end for supporting the connector end, and slipable relative to the first sleeve body; and a positioning member for changing the relative position between the first sleeve body and the second sleeve body from a first position to a second position in response to an external force applied on the first and second sleeve bodies, and securing the first and second sleeve bodies at the second position when the external force is removed, thereby adjusting the length of the vehicular power plug. While this patent is for an adjustable end cap, the end cap is not configured for use in a sound bar.

U.S. Pat. No. 11,082,761 issued on Aug. 3, 2012, to Adam John Bowers and is titled Variable Length Soundbar. This patent discloses a variable length soundbar broadly comprising a number of leveling brackets, an elongated alignment bar, a number of speakers mounting brackets, a number of speakers, and a grille. The leveling brackets include a vertical screw leveler for leveling the elongated alignment bar and hence the speakers. The speaker mounting brackets are configured to be laterally spaced from each other on the elongated alignment bar. The grille and the elongated alignment bar are configured to be resized to a desired length. While this patent discloses a variable length sound bar, the adjustment is not made with the end cap(s).

What is needed is an adjustable sound bar end cap that allows the horizontal length of the end cap to be adjustable to accommodate different widths of finishes and materials. The proposed adjustable sound bar end cap disclosed in this document provides the solution.

### BACKGROUND OF THE INVENTION

Sound bar speakers are often used to enhance the audio experience while watching a television or computer monitor. In general, these sound bars are configured in an elongated shape to fit under, over or on a side of the television or monitor. To maintain a consistent appearance of the sound bar with the television, the sound bar and or end caps are constructed with end caps having different finishes or materials. This results in differences to the overall length of the sound bar. To combat the difference in the length of the sound bar there is a need to make the sound bar length adjustable to match the width of the television.

### SUMMARY OF THE INVENTION

It is an object of the adjustable sound bar end cap to allow for the end caps to be outwardly adjustable relative to the frame. The end caps translate in or out of the frame to provide movement of the end caps for width adjustment. Over the travel length the end caps cover at least a portion of the frame and grill.

It is an object of the adjustable sound bar end cap to be individually adjustable to exact variations due to differences in finishes widths per different brands. The adjustable end caps allow this sound bar to match like size (like a 55″) to exact variations due to differences in finishes widths per different brands.

It is another object of the adjustable sound bar end cap to utilize internal springs that pushes the end caps out from the frame. The use of two springs allows for even movement of the end cap relative to the frame. The springs maintain a constant pressure between the frame and the end cap(s), so they provide a constant force to allow for even adjustment. This configuration gives 0 to 1 inch of movement per side, but the maximum movement could be limited to ¼ inch, ½ inch or some other finite amount. It is also contemplated that the adjustable end cap(s) could be designed to allow for movement of greater than 1 inch of travel per side.

It is another object of the adjustable sound bar end cap is to use threaded fasteners to adjust the expansion of the end caps. The threaded fastener compresses the spring to remain in compression. Using two or more threaded fasteners allows for even compression and perpendicular fit of the end cap relative to the frame.

It is still another object of the adjustable sound bar end cap to include a cover plate that covers the adjustment mechanism and adjustment screws. The cover is made from a ferrous material that is attracted to a magnet within the frame to allow for secure holding of the cover plate and easy removal with common tools. While a magnet is described, the cover plate could be secured with adhesives, glue, snaps, or other means.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 shows a perspective view of a sound bar with adjustable end caps on both sides.

FIG. 2 shows an end view of the sound bar with adjustable end caps.

FIG. 3 shows a top sectional view of the sound bar with adjustable end caps taken though line 3-3 of FIG. 2.

FIG. 4 shows a top sectional view of the sound bar with adjustable end caps taken though line 4-4 of FIG. 2.

FIG. 5 shows a top plan view of the sound bar with adjustable end caps.

FIG. 6 shows a side sectional view of the sound bar with adjustable end caps taken though line 6-6 of FIG. 5.

FIG. 7 shows a side sectional view of the sound bar with adjustable end caps taken though line 7-7 of FIG. 5.

FIG. 8 shows a perspective exploded view of one end of the sound bar with adjustable end caps.

FIG. 9 shows another perspective exploded view of one end of the sound bar with adjustable end cap.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

Item Numbers and Description

| | |
|---|---|
| 10 sound bar | 14 screw hole |
| 15 woofer | 16 tweeter |
| 17 mid-range | 18 grill |
| 19 frame | 20 adjustable end cap |
| 21 logo/indicia | 22 end block |
| 23 spring | 24 spacer/cushion |
| 25 magnet | 26 screw(s) |
| 27 pocket | 28 recess |
| 29 screw clearance | 30 tapped hole |
| 31 fastener | 32 outer edge |
| 33 curve | 34 clearance hole |
| 35 recess | 36 clearance hole |
| 37 hole | 38 head |
| 40 spring pocket | 41 gap |
| 42 threaded hole | 80 riser |
| 81 “S” bracket | 82 tab |
| 90 phantom location | 97 outward |
| 98 turned | 99 expand |

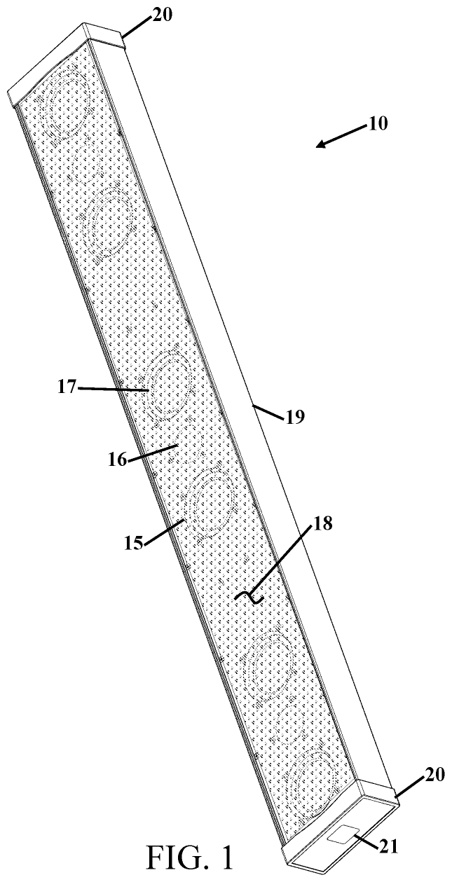

FIG. 1 shows a perspective view of a sound bar 10 with adjustable end caps 20 on both sides. This is a typical configuration of a sound bar 10 that is essentially an elongated frame 19 with one or a plurality of speakers. In this embodiment there is a plurality of speakers including one or more woofers 15, mid-range 17 and/or tweeters 16. This embodiment shows three sets of woofers 15, mid-range 17 and tweeters 16, but more, different, or fewer speakers can be used in the sound bar 100. The elongate frame 19 is configured for placement above, below or on the sides of a television or monitor (not shown).

A grill 18 is shown covering the speakers to provide protection to the speakers and provide a uniform front appearance. The grill is normally an open weave fabric that allows should pass through grill 19, but in some contemplated embodiments the grill 18 can be an open metal cage or mesh. Frame 19 is an elongated “U” shape with a fixed length. When different finishes or materials are placed or used with the end cap, the overall length of the sound bar 10. To ensure that the total length of the sound bar 10 remains the same with different materials and finishes the end cap(s) are adjustable end caps 20 that allow some limited adjustment of the adjustable end cap(s) 20 relative to the frame 19. The adjustable end cap(s) 20 are shown with an indicia cap 21 that provides manufacturer or advertising.

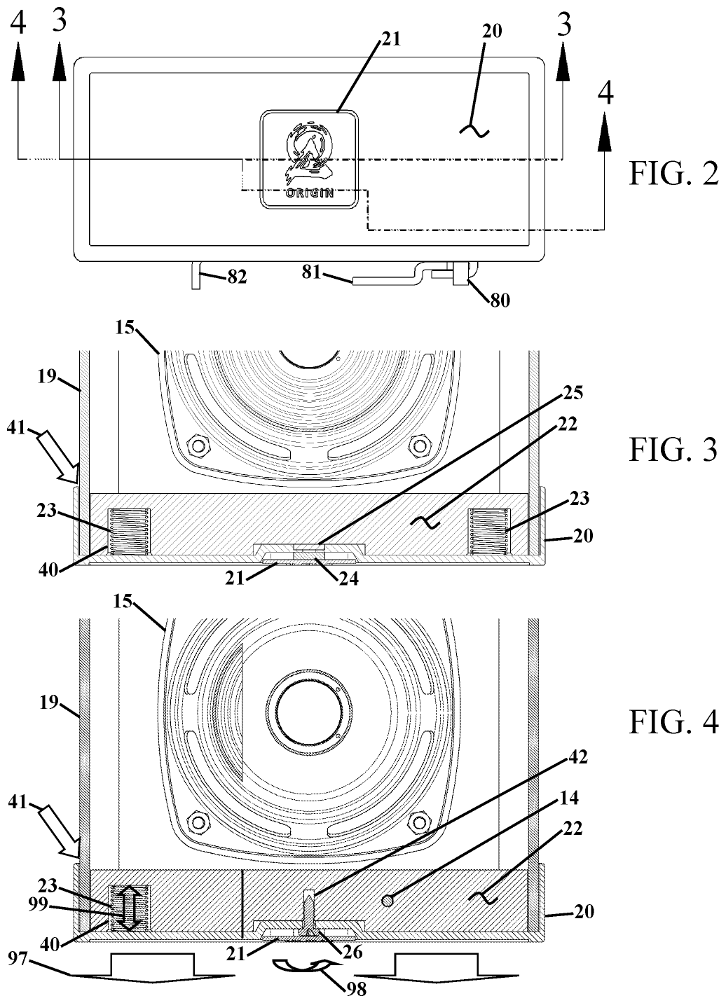

FIG. 2 shows an end view of the sound bar with adjustable end caps, FIG. 3 shows a top sectional view of the sound bar with adjustable end caps 20 taken though line 3-3 of FIG. 2 and FIG. 4 shows a top sectional view of the sound bar with adjustable end caps 20 taken though line 4-4 of FIG. 2. In FIG. 2 some mounting or securing hardware including a riser 80, “S” bracket 81 and tab 82 is shown for mounting the sound bar on a surface. Various mounting hardware may be used and is not intended to limit the function of the adjustable end cap(s) 20. From FIG. 2, the section 3-3 passes horizontally through the end cap 20 so it horizontally bisects spring 23. In the section 4-4 the section line is staggard to pass through only one of the two springs 23, and steps to pass through one screw 26 under the logo cap or indicia 21. Referring now to FIGS. 3 and 4.

In FIGS. 3 and 4 a speaker 15 (woofer) is shown secured within frame 19. The end block 22 is secured to frame 19 with one or plurality of fasteners. In FIG. 4 a screw hole 14 with a fastener is shown for securing the end block 22 to the frame 19. Placing a fastener through the screw hole 14 will essentially lock the adjustable end cap 20 in position on the sound bar. The moving part of the adjustable end cap 20 is with the spring(s) 23 that push or expand 99 between the end of the spring pocket 40 and the inside of each adjustable end cap 20. A logo plate with indicia 21 covers screw(s) that allow for adjustment of the end cap 20. The side walls of end cap 20 extend along the sides of frame 19 and have clearance or a gap 41 that allows the adjustable end cap 20 some limited movement on frame 19. Under the logo plate 21 is a spacer/cushion 24 and a magnet 25. The logo plate 21 is preferably made from a ferrous material so it is held with magnetic attraction to magnet 25 within adjustable end cap 20.

As the screw 26 turned 98 within a threaded hole 42 the adjustable end cap 20 is pulled into the end block 22. Conversely, if the screw 26 is turned 98 in the opposite direction the spring(s) 23 will push or expand 99 the adjustable end cap 20 outward 97. After adjustment the logo plate 21 is re-installed in the adjustable end cap 20. Future adjustment can be made by removing the logo plate 21 and again adjusting the screw (s) 26.

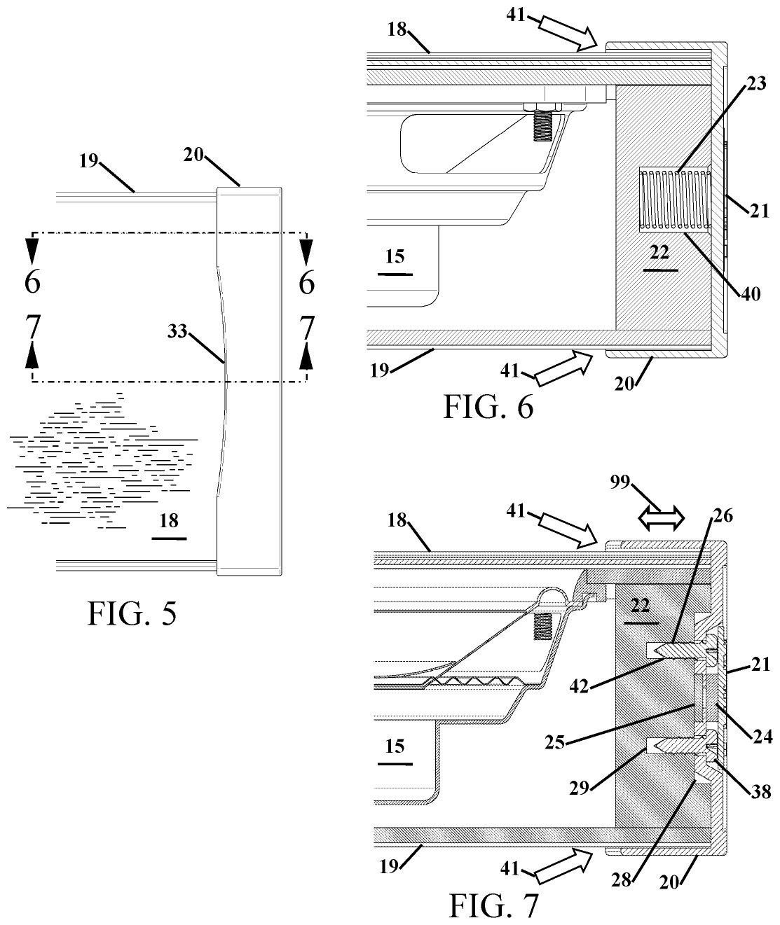

FIG. 5 shows a top plan view of the sound bar with adjustable end cap(s) 20, FIG. 6 shows a side sectional view of the sound bar with adjustable end cap(s) 20 taken though line 6-6 of FIG. 5 and FIG. 7 shows a side sectional view of the sound bar with adjustable end cap(s) 20 taken though line 7-7 of FIG. 5. The adjustable end cap(s) 20 is FIG. 5 shows that the edge of the adjustable end cap(s) 20 can be curved 33 relief to make clearance for the speaker shape. In FIG. 6 the section line passes vertically bisecting one of the springs 23 in the spring pocket 40. A portion of the speaker 15 is shown in this figure. The adjustable end cap 20 is shown passing over the grill 18 and under the frame 19. There are some clearance gaps 41 between the adjustable end cap 20 and the grill 18 and frame 19 to allow for the adjustable end cap 20 to move on the frame 19 and grill 18. The compression spring 23 pushes the adjustable end cap 20 out, as it expands between the bottom of the spring pocket 40 and the inside of the adjustable end cap 20. The amount of expansion of the compression spring 23 is controlled by the screws 26 as shown in sectional view of FIG. 7. The screw(s) 26 are configured to move the adjustable end cap 20 relative to the end block 22 as the adjustable end cap 20 alters the compression of the spring(s) 23.

In FIG. 7, screws 26 are shown threaded into the threaded holes 42. There is a screw clearance 29 in the bottom of the threaded holes 42. While the screw clearance is shown as a closed bottom, it could also be fabricated as a through hole to allow for greater travel of the adjustable end cap(s) 20. The head 38 of the screws 26 is located on the outside wall of the adjustable end cap 20, and the shaft of each screw 26 passes through the adjustable end cap 20 where they thread into the threaded hole 42 in the end block 22. The two screws 26 are independently adjustable to ensure that the adjustable end cap 20 is squarely positioned with respect to the frame 19 and the grill 18. The expansion 99 of the springs 23 (in FIG. 6) is limited by the screws 26. The shape of the adjustable end cap 20 allows the center of the adjustable end cap 20 to fit within a recess 28 in the end block 22. Magnet 25 is positioned between the end block 22 and the adjustable end cap 20. On the outside of the adjustable end cap 20 is a spacer cushion 24. On the outside of the adjustable end cap 20 is a logo/indicia plate 21 that is magnetically attracted to magnet 25. The logo/indicia plate 21 covers the screws 26 to prevent tampering and provide a cosmetic finish.

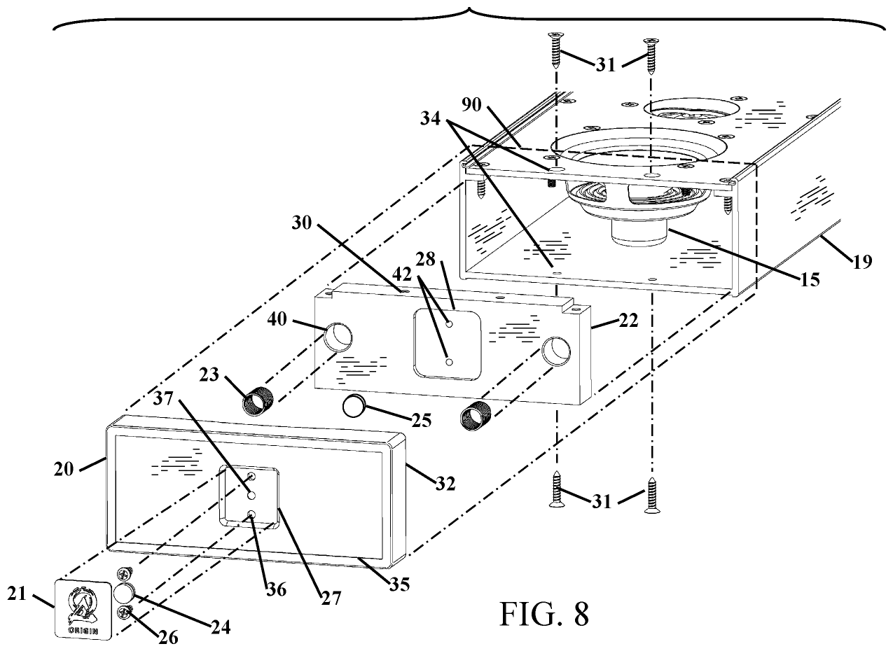

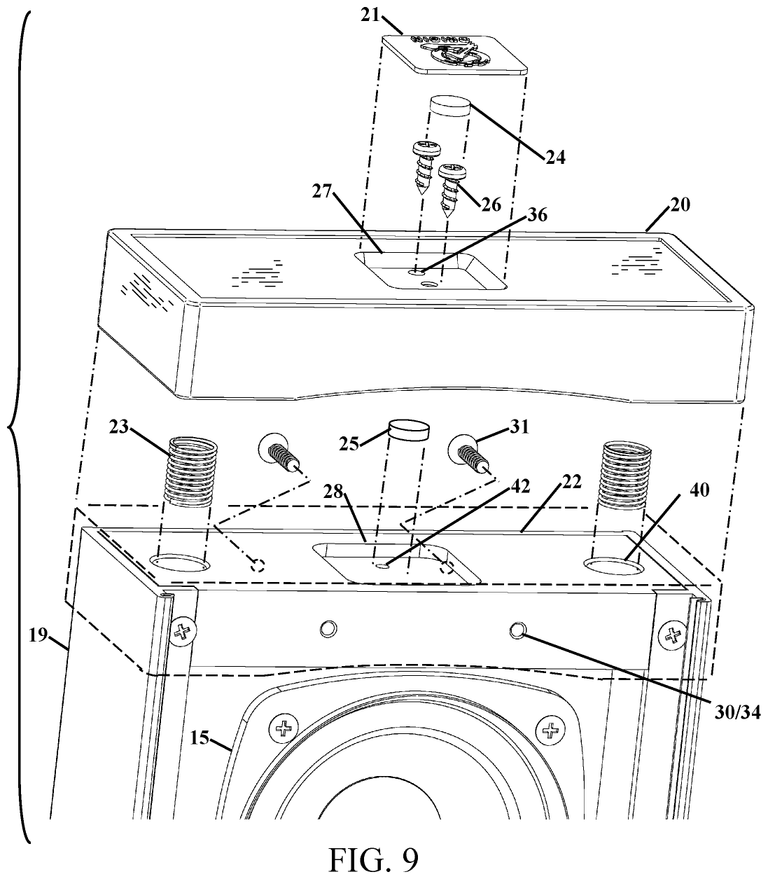

FIG. 8 shows a perspective exploded view of one end of the sound bar with adjustable end cap(s) 20 and FIG. 9 shows another perspective exploded view of one end of the sound bar with adjustable end cap(s) 20. Adjusting the position of the adjustable end cap(s) 20 allows the overall length of the sound bar to be adjusted to accommodate exact variations due to differences in finishes widths. The adjustable end cap(s) 20 are made from essentially 4 pieces, the adjustable end cap(s) 20, the end block 22, the springs 23 and the screws 26. This configuration gives 0 to 1 inch of movement per side, but the maximum movement could be limited to ¼ inch, ½ inch or some other finite amount. It is also contemplated that the adjustable end cap(s) 20 could be designed to allow for movement of greater than 1 inch of travel per side. The phantom location 90 of the adjustable end cap 20 is shown in broken line.

Each end block 22 is fitted and secured in the frame 19 using fasteners 31 that pass though clearance holes 34 and are secured in the end block(s) 22 into holes 30 therein. Within frame 19 one or a plurality of speakers 15 is/are secured therein. The adjustable end cap(s) 20 are adjusted relative to the end block 22 secured in frame 19. Each end block 22 has a recess 28 for clearance of the depressed pocket 27 of the adjustable end cap(s) 20. There are threaded 42 or tapped or simply interference holes for the screws 26 the thread into the end block 22 that allows the position of the adjustable end cap(s) 20 to be set or re-adjusted. In the end block 22 are at least two spring pockets 40 where the spring(s) 23 are inserted to press between the bottom of the spring pocket and the back of the adjustable end cap(s) 20.

The outer edge 32 of the adjustable end cap(s) 20 is sized to translate and guide along the sides of the frame 19. Screws 26 pass through clearance holes 36 in the adjustable end cap(s) 20 and thread into threaded holes 42 in the end block 22. The screws 26 can be adjusted to alter the amount of compression in spring 23 as well as the in/out position of the adjustable end cap(s) 20 relative to the frame 19. To finish the outer end of the adjustable end cap(s) 20 and to cover the screw(s) 24 a logo/indicia 21 cover plate is used. In a preferred embodiment the logo/indicia 21 cover plate is made from a ferrous material that is attracted to a magnet 25. A cushion 24 can be placed behind the logo/indicia 21 cover plate. It is also contemplated that the cover plate could be glued or secured with adhesive.

Thus, specific embodiments of an adjustable sound bar end cap to have been disclosed. It should be apparent, however, to those skilled in the art that many more modifications besides those described are possible without departing from the inventive concepts herein. The inventive subject matter, therefore, is not to be restricted except in the spirit of the appended claims.

1. An adjustable sound bar end cap comprising:
at least one speaker secured within a frame structure;
said frame structure having an end block secured therein;
an adjustable end cap that has an outer edge that at least partially wraps around said frame structure;
at least one spring positioned between said end block and said adjustable end cap that is configured to push said adjustable end cap away from said end block, and
a threaded fastener that is configured to move said adjustable end cap relative to said end block as said adjustable end cap alters the compression of said at least one spring.

2. The adjustable sound bar end cap according to claim 1, wherein there are at least two springs.

3. The adjustable sound bar end cap according to claim 1, wherein said least one spring is a compression spring.

4. The adjustable sound bar end cap according to claim 1, wherein said at least one spring is restrained within a spring pocket in said end block.

5. The adjustable sound bar end cap according to claim 4, wherein said at least one spring is at least partially covered by said adjustable end cap.

6. The adjustable sound bar end cap according to claim 1, wherein there are at least two threaded fasteners.

7. The adjustable sound bar end cap according to claim 6, wherein the at least two threaded fasteners or independently adjustable.

8. The adjustable sound bar end cap according to claim 1, wherein the adjustable end cap is configured to translate away from said frame structure.

9. The adjustable sound bar end cap according to claim 8, wherein the adjustable end cap is configured to translate is between 0 inches and 1 inch.

10. The adjustable sound bar end cap according to claim 1, further includes a logo plate.

11. The adjustable sound bar end cap according to claim 10, wherein said logo plate at least partially covers said threaded fastener.

12. The adjustable sound bar end cap according to claim 10, wherein said logo plate is retained on said adjustable end cap with a magnet.

13. The adjustable sound bar end cap according to claim 10, wherein said logo plate is retained on said adjustable end cap with an adhesive.

14. The adjustable sound bar end cap according to claim 1, includes a second adjustable end cap.

15. The adjustable sound bar end cap according to claim 14, wherein said adjustable end cap and said second adjustable end cap are configured to provide a total change in a width of said sound bar of between 0 and 2 inches.

16. The adjustable sound bar end cap according to claim 1, further includes hardware for mounting said adjustable sound bar on a flat surface.

17. The adjustable sound bar end cap according to claim 1, further includes at least one hole that accepts a fastener to lock said adjustable end cap in a position on the sound bar.

18. The adjustable sound bar end cap according to claim 1, wherein there is clearance between sides of said adjustable end cap and said frame structure.

19. The adjustable sound bar end cap according to claim 1, wherein said adjustable end cap has a relief to make clearance for said at least one speaker.

20. The adjustable sound bar end cap according to claim 1, wherein said at least one speaker is at least one woofer and at least one mid-range speaker.
